(19) United States
(12) Patent Application Publication
(10) Pub. No.: US 2011/0288785 A1
(43) Pub. Date: Nov. 24, 2011

(54) COMPRESSION OF GENOMIC BASE AND ANNOTATION DATA

(75) Inventor: Waibhav Deepak Tembe, Phoenix, AZ (US)

(73) Assignee: TRANSLATIONAL GENOMICS RESEARCH INSTITUTE (TGEN), Phoenix, AZ (US)

(21) Appl. No.: 13/109,710

(22) Filed: May 17, 2011

Related U.S. Application Data
(60) Provisional application No. 61/345,675, filed on May 18, 2010.
(60) Provisional application No. 61/370,654, filed on Aug. 4, 2010.

(51) Int. Cl. G06F 19/00

(52) U.S. Cl. 702/20

(57) ABSTRACT

A genomic data computer system receives a data set comprising sequenced genomic bases and associated annotations that form sequenced base-annotation pairs. The computer system determines a frequency distribution for the base-annotation pairs in the data set. The computer system determines variable-length identification codes for the base-annotation pairs based on the frequency distribution. The computer system converts the sequenced base-annotation pairs into a corresponding series of the variable-length identification codes that require a smaller amount of storage than the original data.

### RELATED CASES

This patent application claims the benefit of U.S. provisional patent application 61/345,675; entitled “Methods of Compression of Genomic Sequencing Data”; filed on May 18, 2010; and that is hereby incorporated by reference into this patent application. This patent application also claims the benefit of U.S. provisional patent application 61/370,654; entitled “Methods of Compression of Genomic Sequencing Data”; filed on Aug. 4, 2010; and that is hereby incorporated by reference into this patent application.

### TECHNICAL BACKGROUND

Biological cells contain nucleic acid molecules that drive the production of proteins and other biological materials for cell reproduction. These nucleic acid molecules have complex atomic structures called nucleotide bases. The nucleotide bases are connected in sequences to form the nucleic acid molecules. The study of these nucleotide base sequences is central to current medical progress. By correlating diseases, treatments, etc. to various nucleotide base sequences, cures for cancer and other genetic disorders will be developed. This future includes personalized medicine where an individual's own nucleic acid is sequenced and processed to select the best treatments for that individual's specific medical condition.

Nucleic acid sequencing attempts to identify the sequence of nucleotide bases in a nucleic acid molecule. Sequencing machines implement various technologies to analyze nucleic acid samples and provide data indicating the sequence of the nucleotide bases. The sequence data usually identifies the bases with a lettering scheme (A=adenine, C=cytosine, G=guanine, etc.), although colors or other symbols and methodologies may be used. Due to the difficulty of detecting nucleotide sequences, many sequencing machines also produce metrics that characterize the detection accuracy of each identified base. The base identifications are referred to as base calls, and the accuracy metrics are referred to as base call quality scores. The base call quality scores and associated error conditions are typically indicated by letters, numbers, and other symbols (F, P, @, etc.). A few examples of error conditions include sequence error, inconclusive detection, no result, and the like. The base call quality scores and error conditions are a form of base call annotation. Other base call annotations include the read number, text notes, genome values, color space data, or some other information related to the base call.

Due to the huge number of nucleotides in a nucleic acid molecule, one sequencing operation produces an immense data set. This immense data set comprises a sequence of letters and other symbols that represent the base calls and quality scores for multiple reads. The number of these sequencing operations is also growing dramatically as newer and better sequencing machines are developed. Thus, the amount of genomic sequence data being produced is truly massive and threatens to overwhelm the current genomic data infrastructure including data storage systems, communication networks, processing circuitry, and analysis software. Unfortunately, this threat to the genomic data infrastructure also threatens the hoped-for development of cures, treatments, and personalized medicine.

In some current genomic data compression methodologies, bases and annotations are compressed into fixed-length bit strings. Unfortunately, the fixed-length bit strings may be too small and restrict the number of different base calls and annotations that could be used. This restriction on the number and granularity of base calls and annotations restricts medical progress. Conversely, the fixed-length bit strings may be too large for the number of different base calls and annotations that are actually used. Thus, each compressed base-annotation pair would include unnecessary bits, since high-resolution base calls and annotations were not used. The resulting unnecessary data load further burdens the already over-burdened genomic data infrastructure.

### Overview

A genomic data computer system receives a data set comprising sequenced genomic bases and associated annotations that form sequenced base-annotation pairs. The computer system determines a frequency distribution for the base-annotation pairs in the data set. The computer system determines variable-length identification codes for the base-annotation pairs based on the frequency distribution. The computer system converts the sequenced base-annotation pairs into a corresponding series of the variable-length identification codes that require less storage than the original data. The genomic data computer system may be controlled by software that can be stored on a computer-readable medium.

### BRIEF DESCRIPTION OF THE DRAWINGS

FIG. 1 illustrates a genomic data computer system to compress genomic base-annotation pairs.

FIG. 2 illustrates the operation of a genomic data computer system to compress genomic base-annotation pairs.

FIG. 3 illustrates the operation of a genomic data computer system to compress and format genomic base-quality pairs from a genomic sequencing machine.

FIG. 4 illustrates a data structure to assign identification codes to base-quality pairs.

FIG. 5 illustrates a genomic data computer system to compress genomic base-annotation pairs and perform pattern matching on the compressed data responsive to API calls.

FIG. 6 illustrates an operating environment for a genomic data computer system that compresses genomic base-annotation pairs.

FIG. 7 illustrates a genomic sequencer with integrated genomic base-annotation data compression.

### DETAILED DESCRIPTION

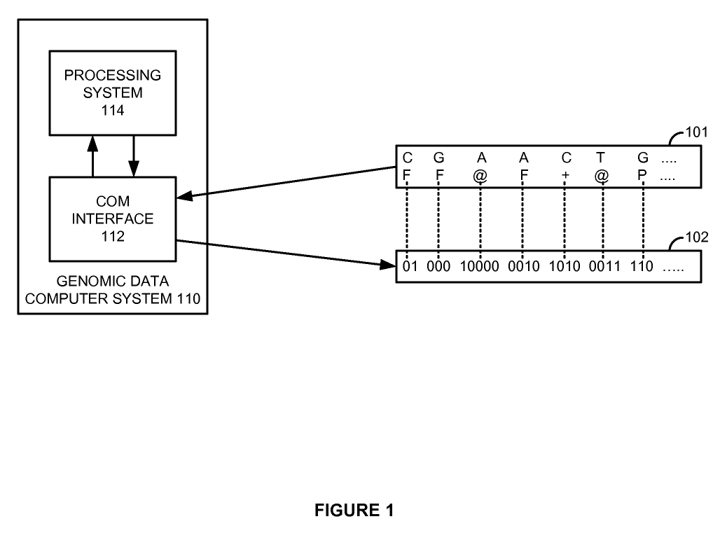

FIG. 1 illustrates genomic data computer system 110. Genomic data computer system 110 comprises communication interface 112 and processing system 114. Communication interface 112 receives genomic data set 101 for processing system 114. Processing system 114 converts genomic data set 101 into compressed data set 102, and communication interface 112 transfers compressed data set 102. Communication interface 112 comprises circuitry, memory, and software configured to receive and transfer data signals for processing system 114. Processing system 114 comprises circuitry, memory, and software configured to compress genomic data as described herein.

Data set 101 includes a sequence of genomic base symbols (C, G, A, A . . . ) that are individually associated with annotation symbols (F, F, @, F . . . ). Thus, each associated base and annotation forms a base-annotation pair (CF, GF, A@, AF . . . ). The sequence of bases represents the sequence of nucleotides of a nucleic acid molecule. The annotations comprise data related to the bases, such as base call quality scores, error conditions, color space data, text notes, and the like. Data set 101 could be produced by a genomic sequencer, but data set 101 may also be stored or transferred by various different systems, so communication interface 112 may receive data set 101 from a number of different sources. In addition, data set 101 may use any sequencing and annotation format that has a finite set of symbols to indicate a finite set of base-annotation pairs. Various different sequencing technologies could be used.

Data set 102 comprises a series of variable length identification codes. As indicated on FIG. 1 by the dotted lines, each identification code in data set 102 represents a specific base-annotation pair in data set 101. For example, identification code “01” in data set 102 represents the base-annotation pair “CF” in data set 101. Base-annotation pairs that occur more frequently in data set 101 are assigned shorter identification codes in data set 102, and base-annotation pairs that occur less frequently in data set 101 are assigned longer identification codes in data set 102. Note that the sequence of base-annotation pairs in data set 101 is maintained by the series of identification codes in data set 102.

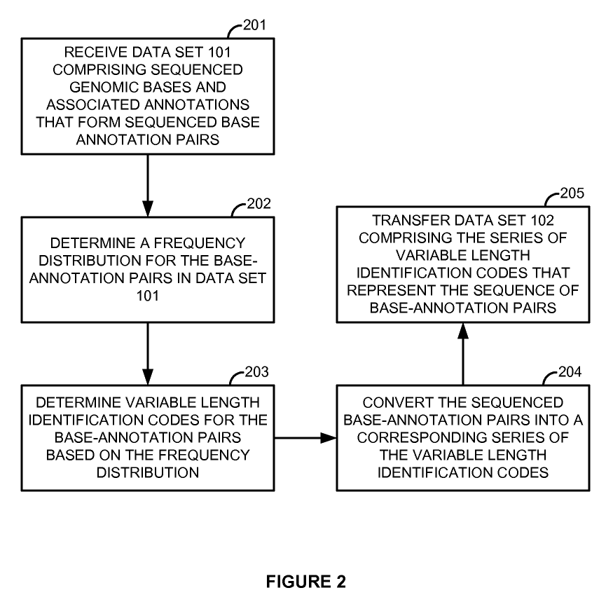

FIG. 2 illustrates the operation of genomic data computer system 110 to compress genomic base-annotation pairs. Genomic data computer system 110 receives data set 101 that comprises sequenced genomic bases and associated annotations that form base-annotation pairs (201). Genomic data computer system 110 determines a frequency distribution for the base-annotation pairs in data set 101 (202). To determine the distribution, computer system 110 counts the total number of instances of each base-annotation pair in relation to the other pairs. Genomic data computer system 110 then determines a variable-length identification code for each base-annotation pair based on the frequency distribution (203).

The identification codes are variable length bit strings where the codes with fewer bits are assigned to higher-frequency base-annotation pairs, and the codes with more bits are assigned to lower-frequency base-annotation pairs. Genomic data computer system 110 converts the sequenced base-annotation pairs into a series of identification codes based on the pair-code assignments to maintain the original data sequence (204). Genomic data computer system 110 then transfers data set 102 comprising the series of identification codes that represent the sequence of base-annotation pairs (205). This data transfer could be a local transfer to a storage device or processing system, or could be a remote transfer over a communication network.

In some examples, a single annotation is indicated by a single symbol. In other examples, multiple annotations are combined and represented by a single symbol. For example, the combination of a given quality score and a given status condition could be represented by a single annotation symbol. In addition, one or more annotations could be indicated by a set of symbols. For example, a given quality score could be represented multiple symbols, or the combination of the given quality score and the given status note could be represented by multiple symbols. The compression process remains the same, because a combination of annotation symbols would be treated as a single unique symbol for the purposes of generating the frequency distribution and translation table. Thus, the term “annotation” as used herein is not restricted to its singular meaning and refers to one or more annotations Likewise, the term “symbol” as used herein is not restricted to the singular meaning and refers to one or more symbols. For clarity, the terms “annotation” and “symbol” are used instead of the terms “annotation(s)” and “symbol(s)”.

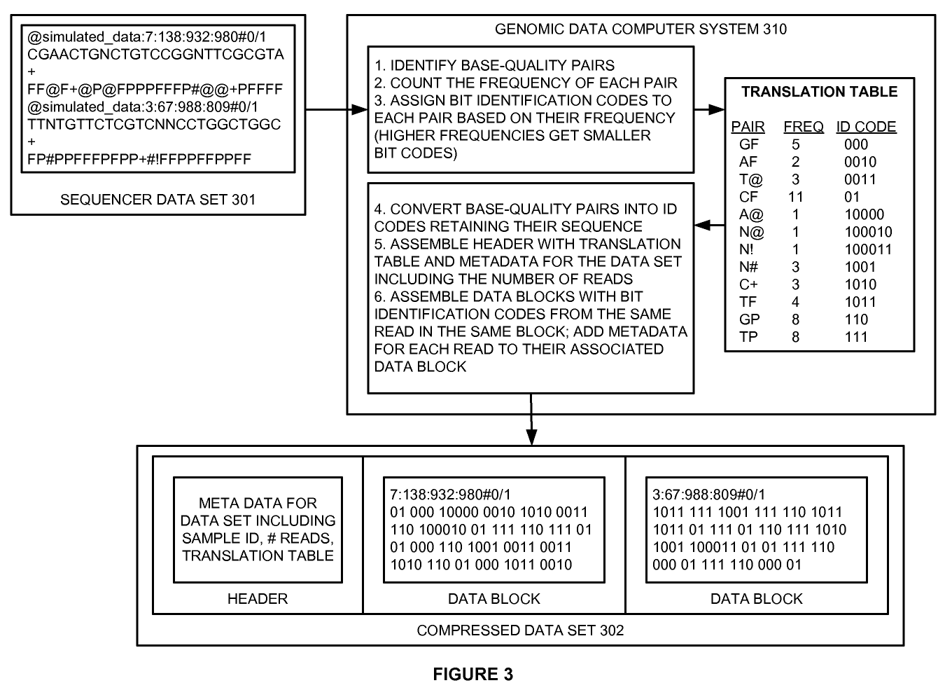

FIG. 3 illustrates the operation of genomic data computer system 310 to compress and format genomic base-quality pairs from a genomic sequencing machine. Genomic data computer system 310 is an example of computer system 110, although system 110 may implement alternative configurations and operations. The genomic sequencing machine that generates sequencer data set 301 may use various sequencing technologies, such as dye termination, pyrosequencing, polony, massively parallel, bridge amplification, ligation, clonal, ion semi-conductor, and the like. Sequencer data set 301 includes a sequence of base-annotation pairs. In this example, the annotations are base call quality scores and error conditions. Error conditions include error call, no call, incomplete sequence, erroneous sequence, user error, machine error, inconclusive detection, and the like. Sequencer data set 301 also includes metadata such as the sample name, sequencer platform, number of reads, and the like.

In step #1, genomic data computer system 310 identifies the different base-quality pairs in the data set. In step #2, computer system 310 counts the frequency of each pair to generate the frequency distribution. In step #3, computer system 310 assigns a variable-length identification code to each base-quality pair based the frequency distribution. Thus, genomic data computer system 310 produces a translation table associating the base-quality pairs with frequency, identification code, and possibly other data.

In step #4, genomic data computer system 310 converts the sequence of base-quality pairs into a corresponding series of identification codes—retaining the original sequence in the compressed series. In step #5, computer system 310 assembles a data header with metadata for the data set, such as the sample name, sequencer technology, number of reads, text notes, and the like. Computer system 310 also loads the translation table (or corresponding data structure) into the header. In step #6, computer system 310 assembles data blocks with the series of identification codes allocated to the data blocks by read. Thus, the identification codes for a sequence of base-quality pairs from a given sequencer read are placed in the same data block. Read-specific metadata, such as the specific read number, is also placed in the data block for the given sequencer read.

Genomic data computer system 310 compresses sequencer data set 301 into compressed data set 302. Note that compressed data set 302 includes metadata from sequencer data set 301. Compressed data set 302 maintains the sequence of data set 301. Compressed data set 302 also includes the translation table to convert between the identification codes and the base-quality pairs. Note that compressed data set is indexed by read/data block, so the data from a given read or the data from a portion of a given read may be accessed and decoded independently from the remaining compressed data.

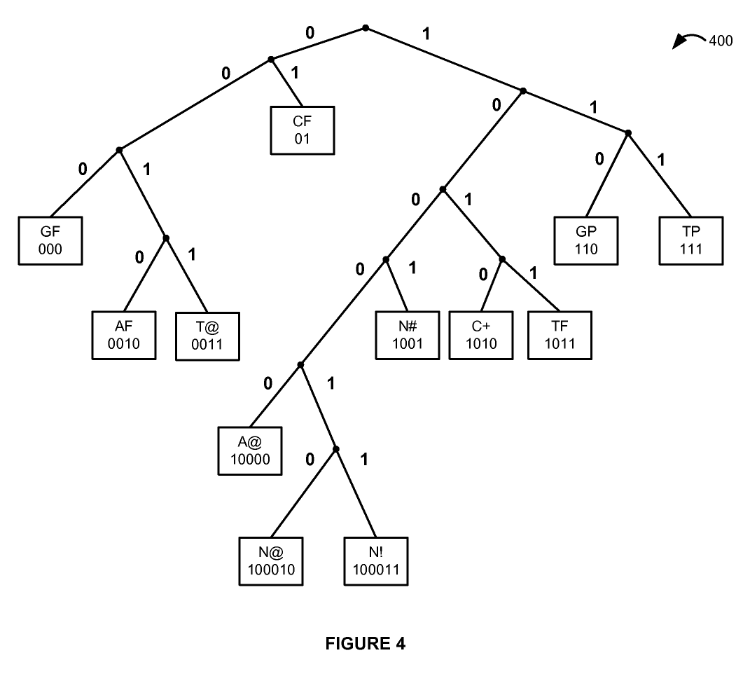

FIG. 4 illustrates data structure 400 to assign variable-length identification codes to base-quality pairs. Data structure 400 provides an example of the selection and assignment of identification codes to base-quality scores, although other techniques to assign variable-length identification codes to base-quality pairs based on their frequency distribution could be used. Data structure 400 comprises a Huffman tree and the resulting variable length bit strings comprise Huffman codes. Note the branching of data structure 400 with 0 bits branching to the left and 1 bits branching to the right. Note that the Huffman codes do not share prefixes to provide unambiguous decoding.

When the frequency distribution is determined, then base-quality pairs are assigned to the Huffman codes so the highest frequency pair gets the shortest Huffman code, the next highest frequency pair gets the next shortest Huffman code, and so on. The assignment of Huffman codes to base-quality pairs shown on data structure 400 is reflected in the translation table of FIG. 3.

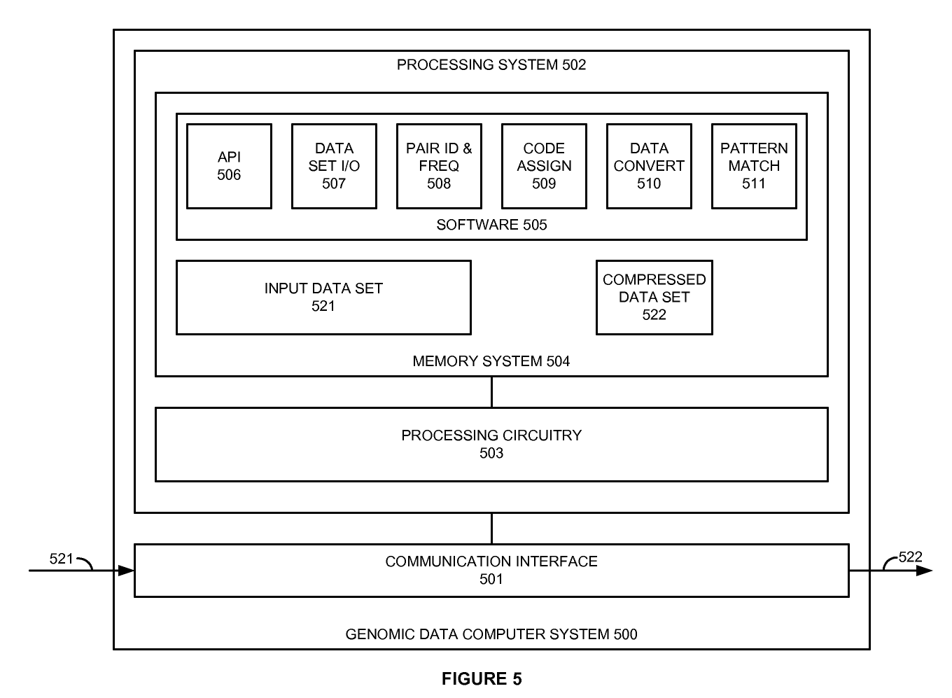

FIG. 5 illustrates genomic data computer system 500 to compress genomic base-annotation pairs and perform pattern matching on the compressed data in response to API calls. Genomic data computer system 500 provides an example of computer systems 110 and 310, although systems 110 and 310 may use alternative configurations and operations. Genomic data computer system 500 comprises communication interface 501 and processing system 502. Processing system 502 is linked to communication interface 501. Processing system 502 includes processing circuitry 503 and memory system 504 that stores software 505. Software 505 comprises software modules 506-511.

Communication interface 501 comprises components that communicate over communication links, such as network cards, ports, RF transceivers, processing circuitry, software, memory, or some other communication components. Communication interface 501 may be configured to communicate over metallic, wireless, or optical links. Communication interface 501 may be configured to use time division multiplex, internet protocol, Ethernet, wireless protocol, or some other communication format—including combinations thereof. Communication interface 501 is configured to receive and transfer genomic data sets over communication networks.

Processing circuitry 503 comprises microprocessors and other circuitry that retrieves and executes software 505 from memory system 504. In some examples, processing circuitry is at least a 64-bit system and may represent a multithreaded parallel computing system.

Software 505 comprises computer programs, firmware, or some other form of machine-readable processing instructions. In addition to modules 506-511, software 505 may include an operating system, utilities, drivers, network interfaces, applications, or some other type of software. Processing circuitry 503 may receive API calls from one of these applications—possibly triggered by user interaction with the application.

Memory system 504 comprises a non-transitory computer-readable storage medium, such as disk drives, flash drives, data storage circuitry, or some other memory apparatus. Although shown as physically integrated into computer system 500, at least some portions of memory system 504 may be physically separate and remote from the other components of computer system 500. For example, memory system 504 could comprise an integrated disk drive that stores an operating system and browser, and memory system 504 could also comprise a remote flash drive or server that stores modules 506-511. This flash drive or server could subsequently transfer software modules 506-511 to computer system 500.

When executed by circuitry 503, software 505 directs processing system 502 to operate as described herein for genomic data computer systems. In particular, software 505 directs processing system 502 to identify and compress base-annotation pairs into variable length bit codes, so that the more frequent base-annotation pairs in the data set are encoded with shorter bit strings.

In this example, software 505 comprises modules 506-511. Application Programming Interface (API) 506 processes API calls to direct compression operations and associated tasks. Typical API calls would load data into the system, compress the data, and retrieve the compressed data. Other API calls might decompress previously compressed data and output the data in a selected format. In some examples, the output format could be different than the input format, so that the compression process may effectively be a format translation process. Other API calls could process only portions of the data, such as a specific read, to compress, statistically analyze, and/or transfer data. For example, API module 506 could receive an API call to transfer the compressed data for the third read to a specified destination and to indicate the percent of the base calls in the third read that have a “machine error” quality indicator.

The API calls may be received from applications executing on genomic data computer system 500—possibly in response to user interaction with the applications. The API calls may also be received from external systems, such as remotely-located genomic machines. In some examples, a client-server syntax is used between the remote genomic machines and computer system 500, where the syntax includes instructions that represent the API calls.

Data set I/O module 507 handles incoming data sets for subsequent processing and assembles output data for storage or transfer.

Pair ID and frequency module 508 identifies base annotation pairs in a data set and develops its frequency distribution. Pair ID and frequency module 508 typically has a known list of bases and annotations to look for based on input format, although module 508 could also sort the bases and annotations and develop the list for subsequent pairing and counting.

Code assignment module 509 assigns codes to base-annotation pairs based on the frequency distribution to generate a translation table for the data set. The number of bit codes required is based on the number of different base-annotation pairs, and then this number of bit codes is allocated to give the shortest codes to the most frequent base-annotation pairs.

Data conversion module 510 translates the input data into compressed data using the translation table. In some examples, module 510 generates a header with the metadata and the translation table for the data set, and then module 510 forms data blocks of identification codes on a per-read basis. Module 510 adds read-specific metadata to the data blocks.

Pattern matching module 511 performs data operations on the compressed data by identifying palindromes, repeated data strings, and data permutations. Pattern matching module 511 may find specific types of bit strings, provide statistical analytics, and the like. In some examples, pattern matching module 511 provides another layer of compression by replacing repeating bit patterns with shorter code sequences, or through some other secondary compression technique.

In an operative example, communication interface 501 receives an API call from an external system to receive, compress, and store a genomic data set. API 506 processes the API call and transfers an acknowledgement to the external system. In response, communication interface 501 receives input data set 521 from the external system, and I/O module 507 loads input data set 521 into memory system 504. Pair ID and frequency module 508 identifies the base-annotation pairs and develops the frequency distribution for data set 521. Code assignment module 509 obtains the identification codes, such as Huffman codes, for the number of different pairs and assigns the codes to the pairs based on the frequency distribution. Data conversion module 510 then converts input data set 521 into compressed data set 522 based on these code assignments, and stores compressed data set 522 in memory system 504. Compressed data set 522 could be formatted with a header and data blocks for each read as described herein.

Subsequently, communication interface 501 may receive API calls to transfer compressed data set 522 and to provide a statistical breakdown for data in the fourth read that indicates the top five error conditions associated with the guanine base. API module 506 handles the API calls and acknowledgments. Pattern matching module 511 quantifies the identification codes for guanine in the fourth read to identify the top five codes. I/O module 507 transfers compressed data set 522 and the statistical breakdown through communication interface 501 to the specified destination.

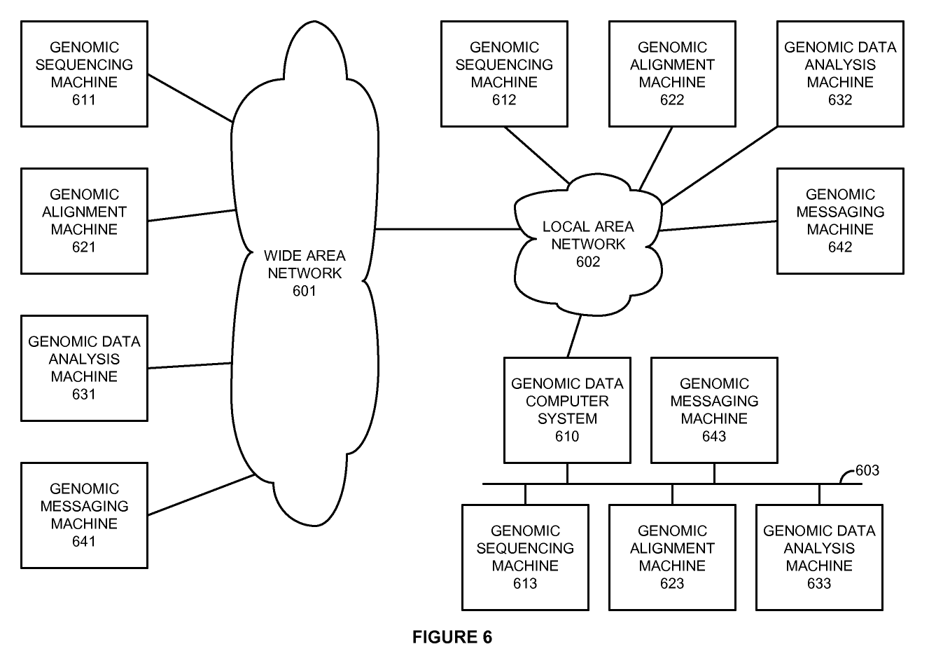

FIG. 6 illustrates operating environment 600 for genomic data computer system 610 that compresses genomic base-annotation pairs. Operating environment 600 includes genomic sequencing machines 611-613, genomic alignment machines 621-623, genomic analysis machines 631-633, and genomic messaging machines 641-643. Operating environment 600 includes wide area network 601, local area network 602, and bus structure 603. Wide area network 601 could be the Internet or some other large-scale communication system. Local area network 602 could be an Ethernet system or some other smaller-scale network. Bus structure 603 comprises a direct machine-to-machine interface.

Genomic machines 611, 621, 631, and 641 digitally communicate with genomic data computer system 610 over wide area network 601 and local area network 602. Genomic machines 612, 622, 632, and 642 digitally communicate with genomic data computer system 610 over local area network 602. Genomic machines 613, 623, 633, and 643 digitally communicate with genomic data computer system 610 over bus structure 603.

Genomic data computer system 610 is an example of computer systems 110, 310, and 500 described above, although these systems may use alternative configurations and operations. Genomic data computer system 610 receives data sets indicating sequenced base reads, associated annotations, and metadata. Genomic data computer system 610 employs a Huffman coding algorithm to encode base-annotation pairs, and may also perform data analytics and formatting as described above.

Any of the genomic machines may transfer genomic data to computer system 610 for compression, decompression, formatting, and analysis. Any of the genomic machines may retrieve genomic data from computer system 610 after compression, decompression, formatting, and analysis. For example, sequencing machine 611 may perform ten reads and transfer the gnomic data to computer system 610 for compression and storage. Genomic data analysis machine 632 may request the third read of the data in the compressed format. Genomic messaging machine 643 may request the first three reads of data in the uncompressed format. In another example, sequencing machine 613 may transfer a genomic data set to computer system 610 for storage and distribution. Computer system 610 would compress the genomic data and transfer three copies of the compressed data to genomic messaging machines 641-643.

Genomic data computer system 610 provides a library of software and/or data to other systems. For example, the other genomic machines on FIG. 6 may dynamically link to the software and/or data in the library. The software may provide various services, such as an access service, query service, modification service, or data retrieval service.

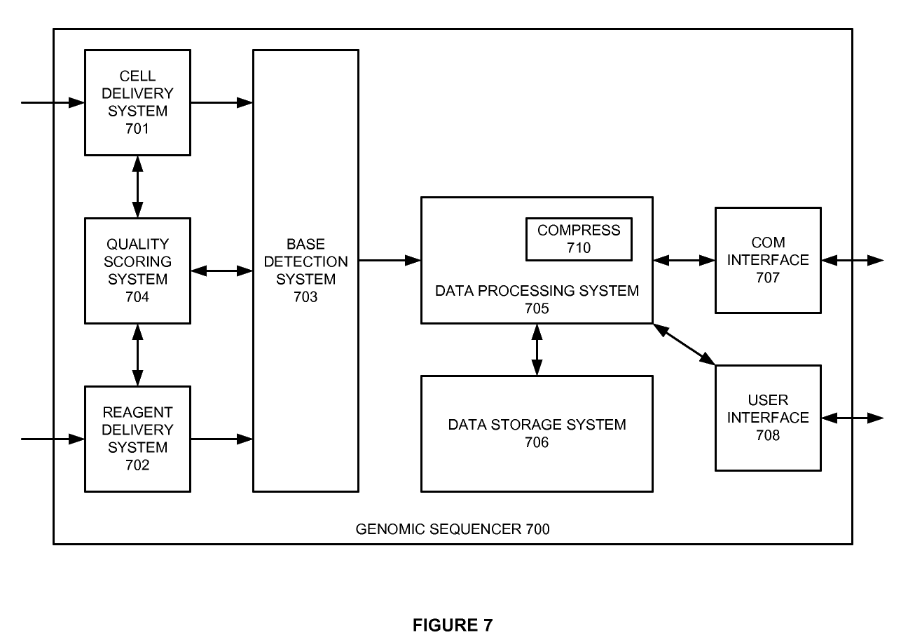

FIG. 7 illustrates genomic sequencer 700 with integrated genomic base-annotation data compression 710. Genomic sequencer 700 includes user interface 708 to receive operator instructions—including compression instructions. Genomic sequencer 700 includes cell delivery system 701 to receive and prepare biological samples for analysis. Reagent delivery system 702 provides the chemicals and compounds used for sequencing operations. Base detection system 703 processes the biological samples and reagents to produce a data sequence based on the nucleotide sequence in the biological sample. Quality scoring system 704 interacts with systems 701-703 to assign a quality score to each base call. Base detection system 703 transfers the sequence of base calls and associated quality scores to data processing system 705.

Data processing system 705 performs analytical operations on the data set. In particular, compression 710 identifies base-annotation pairs and encodes them using a Huffman process. Compression 710 may perform additional processing operations (including more compression) on the data set. Data processing system 705 may store the compressed data set in storage system 706 and/or transfer the compressed data set through communication interface 707 to an external system.

### CONCLUSION

The above-described genomic data computer systems provide advanced flexibility to the symbols that can be used in the base-annotation process. In some prior compression methodologies, base calls and quality scores are compressed into fixed-length bit strings. Unfortunately, the fixed-length bit string may be too small and restrict the number of different base calls and annotations that can be used. This restriction on the number and granularity of base calls and annotations restricts medical progress. The genomic data computer systems described above may readily handle many different base calls and annotations to provide high-resolution analytics and promote medical progress.

In addition, the fixed-length bit string may be too large for the number of different base calls and annotations that are actually present in the data set. Thus, each compressed base-annotation pair includes unnecessary bits, since high-resolution base calls and annotations were not used. The resulting unnecessary data load further burdens and already-stressed genomic data infrastructure. The genomic data computer systems described above right-size the variable-length codes to tailor the data capacity that is consumed to the specific characteristics of the data set. Thus, the genomic data computer systems described above conserve the over-burdened genomic data infrastructure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a genomic data computer system to compress genomic data, the method comprising:
receiving a data set comprising sequenced genomic bases and associated annotations that form sequenced base-annotation pairs;
determining a frequency distribution for the base-annotation pairs in the data set;
determining variable-length identification codes for the base-annotation pairs based on the frequency distribution; and
converting the sequenced base-annotation pairs into a corresponding series of the variable-length identification codes.

2. The method of claim 1 wherein the associated annotations comprise base call quality scores.

3. The method of claim 1 wherein the associated annotations comprise base call error conditions.

4. The method of claim 1 wherein receiving the data set comprises receiving the data set from a nucleic acid sequencing system.

5. The method of claim 1 further comprising processing the series of the identification codes to identify data patterns comprising at least one of: palindromes and matching data strings.

6. The method of claim 1 wherein the data set is developed through genomic sequencing reads and associates each of the base-annotation pairs with one of the genomic sequencing reads, the method further comprising:
generating a header indicating a number of the genomic sequencing reads for the data set and indicating a translation between the base-annotation pairs and the identification codes;
generating data blocks including the identification codes wherein the identification codes from a same one of the reads are located in a same one of the data blocks;
transferring the header and the data blocks to a communication network for delivery to a destination.

7. The method of claim 1 wherein receiving the data set comprises:
receiving an Application Programming Interface (API) call from a nucleic acid sequencing machine;
transferring a positive API response to the nucleic acid sequencing machine; and
receiving the data set from the nucleic acid sequencing machine responsive to the positive API response.

8. The method of claim 1 wherein the variable-length identification codes comprise Huffman codes.

9. A genomic data computer system to compress genomic data comprising:
a communication interface configured to receive a data set comprising sequenced genomic bases and associated annotations that form sequenced base-annotation pairs; and
a processing system configured to determine a frequency distribution for the base-annotation pairs in the data set, determine variable-length identification codes for the base-annotation pairs based on the frequency distribution, and convert the sequenced base-annotation pairs into a corresponding series of the variable-length identification codes.

10. The genomic data computer system of claim 9 wherein the associated annotations comprise base call quality scores.

11. The genomic data computer system of claim 9 wherein the associated annotations comprise base call error conditions.

12. The genomic data computer system of claim 9 wherein the communication interface is configured to receive the data set from a nucleic acid sequencing system.

13. The genomic data computer system of claim 9 wherein the processing system is configured to process the series of the identification codes to identify data patterns comprising at least one of: palindromes and matching data strings.

14. The genomic data computer system of claim 9 wherein the data set is developed through genomic sequencing reads and associates each of the base-annotation pairs with one of the genomic sequencing reads, and wherein:
the processing system is configured to generate a header indicating a number of the genomic sequencing reads for the data set and indicating a translation between the base-annotation pairs and the identification codes;
the processing system is configured to generate a data blocks including the identification codes wherein the identification codes from a same one of the reads are located in a same one of the data blocks;
the communication interface is configured to transfer the header and the data blocks to a communication network for delivery to a destination.

15. The genomic data computer system of claim 9 wherein:
the communication interface is configured to receive an Application Programming Interface (API) call from a nucleic acid sequencing machine;
the processing system is configured to process the API call to generate a positive API response;
the communication interface is configured to transfer the positive API response to the nucleic acid sequencing machine; and
the communication interface is configured to receive the data set from the nucleic acid sequencing machine in response to the positive API response.

16. The genomic data computer system of claim 9 wherein the variable-length identification codes comprise Huffman codes.

17. A genomic data software apparatus wherein a data set comprises sequenced genomic bases and associated annotations that form sequenced base-annotation pairs, the genomic data software apparatus comprising:
compression software configured, when executed by a computer system, to direct the computer system to determine a frequency distribution for the base-annotation pairs in the data set, determine variable-length identification codes for the base-annotation pairs based on the frequency distribution, and convert the sequenced base-annotation pairs into a corresponding series of the variable-length identification codes; and
a non-transitory computer-readable medium that stores the compression software.

18. The genomic data software apparatus of claim 17 wherein the associated annotations comprise base call quality scores.

19. The genomic data software apparatus of claim 17 wherein the associated annotations comprise base call error conditions.

20. The genomic data software apparatus of claim 17 wherein the data set is from a nucleic acid sequencing system.

21. The genomic data software apparatus of claim 17 wherein the compression software is configured, when executed by the computer system, to direct the computer system to process the series of the identification codes to identify data patterns comprising at least one of: palindromes and matching data strings.

22. The genomic data software apparatus of claim 17 wherein the data set is developed through genomic sequencing reads and associates each of the base-annotation pairs with one of the genomic sequencing reads, and wherein:
the compression software is configured, when executed by the computer system, to direct the computer system to generate a header indicating a number of the genomic sequencing reads for the data set and indicating a translation between the base-annotation pairs and the identification codes;
the compression software is configured, when executed by the computer system, to direct the computer system to generate data blocks including the identification codes wherein the identification codes from a same one of the reads are in a same one of the data blocks;
the compression software is configured, when executed by the computer system, to direct the computer system to transfer the header and the data blocks to a communication network for delivery to a destination.

23. The genomic data software apparatus of claim 17 wherein the compression software is configured, when executed by the computer system, to direct the computer system to receive and process an Application Programming Interface (API) call from a nucleic acid sequencing machine to generate and transfer a positive API response to the nucleic acid sequencing machine, wherein the computer system receives the data set from the nucleic acid sequencing machine in response to the positive API response.

24. The genomic data software apparatus of claim 17 wherein the identification codes comprise variable length Huffman codes.
